(19) United States
(12) Patent Application Publication
(10) Pub. No.: US 2013/0166319 A1
(43) Pub. Date: Jun. 27, 2013

(54) COMMUNICATIONS INFRASTRUCTURE FOR SUPPORTING RECOVERY AND FOLLOW-UP FOR PSYCHIATRIC AND/OR ADDICTION DISORDERS

(71) Applicants: Sigurd H. Ackerman, New Canaan, CT (US); Elizabeth E. Moore, New Canaan, CT (US); Heather M. Porter, New Canaan, CT (US); Lisa M. Ruggiero, New Cannan, CT (US); Janet Isdaner, New Canaan, CT (US)

(72) Inventors: Sigurd H. Ackerman, New Canaan, CT (US); Elizabeth E. Moore, New Canaan, CT (US); Heather M. Porter, New Canaan, CT (US); Lisa M. Ruggiero, New Cannan, CT (US); Janet Isdaner, New Canaan, CT (US)

(73) Assignee: SILVER HILL HOSPITAL, New Canaan, CT (US)

(21) Appl. No.: 13/335,920

(22) Filed: Dec. 22, 2011

(51) Int. Cl. G06Q 50/24

(52) U.S. Cl. 705/3

(57) ABSTRACT

The present invention provides a method of providing a recovery support and follow-up service to an individual recovering from a psychiatric and/or addictive disorder following completion of a transitional living program at a psychiatric hospital. The method provides a pro-active, pre-planned, structured communication protocol between members of a recovery support team comprised of a recovering individual, a recovery support advocate, a personal contact of the recovering individual, and a professional contact of the recovering individual. The method also provides having the recovering individual, the personal contact and the professional contact at a scheduled set number of times complete a telephone survey questionnaire regarding the recovery status of the recovering individual; obtaining at set times a set number of random urine toxicology screens from the recovering individual; and inputting all information gathered from the structure dialogues, the survey questionnaires and the random urine toxicology screens into a computer software database.

### FIELD OF THE INVENTION

The invention relates to a specialized communications and database matrix system driving a recovery support and follow-up method and, more particularly, to an apparatus and method of enabling a pro-active, pre-planned, structured communication protocol between members of a recovery support team and an individual in the process of recovering from psychiatric and/or addiction disorders.

### BACKGROUND OF THE INVENTION

Psychiatric and substance abuse treatment facilities often strive to document reliable outcome measurements that demonstrate an individual's successful treatment of his/her addiction and/or psychiatric condition during and after discharging from the treatment facility. Almost 50% of individuals who successfully complete treatment will relapse within the first year following discharge from the treatment facility. A major reason for relapse is the failure of the individual undergoing recovery to follow the prescribed continuing care plan set up for the individual during treatment. Measuring relapse is also problematic as has been recognized in accordance with the invention.

In addition, probably more often than not, there is very little follow-up of and social support for persons recovering from psychiatric and addiction disorders after the person discharges from a treatment facility.

After the individual has left the treatment facility, it is often difficult for healthcare providers to monitor the individual's status and provide support that reinforces information the individual learned during treatment. Similarly, friends and family who want to offer support may find it difficult to assess the individual's status and to communicate critical information on a timely basis. This can result in jeopardizing the health and well-being of the individual. There exists a need, therefore, for a recovery support and follow-up program which optimizes the likelihood of successful and long-term recovery for persons recovering from psychiatric and addiction disorders.

### SUMMARY OF THE INVENTION

The present invention fulfills this need by providing an apparatus and method of providing a recovery support and follow-up service (RSFS) to an individual recovering from psychiatric and/or addictive disorders following completion of a treatment program. In addition the inventive system allows for a much more reliable measurement of the percentage of relapse and the effectiveness of treatment due to an enhanced percentage of participation in communication during the one year following treatment. The invention also, optionally, provides for the development and use of an effectiveness and danger of relapse model. The inventive system comprises an information technology system programmed with a pro-active, pre-planned communication protocol and associated databases. The same are used in an inventive method to organize and transmit information among the individual and recovery team members, each of which has a well defined role and relationship to the recovering individual.

This team is comprised of the individual undergoing recovery; a recovery support advocate; a personal contact of the recovering individual, such as a family member or significant other; and a professional contact of the recovering individual, such as an outpatient clinician or one affiliated with an after-care facility. The system prompts the recovery support advocate to engage in a number of scheduled, structured data collection communications with the recovering individual, the personal contact and the professional contact, and the database storage of such information optionally for subsequent system use and/or use by the recovery support team. The RSFS method comprises structured dialogues between the recovery support advocate and the other members of the recovery support team that provide information about the recovering individual's progress in and/or challenges to his/her recovery. The RSFS method also comprises having the recovering individual, the personal contact and the professional contact at a scheduled set number of times giving the information needed to complete a telephone survey questionnaire comprised of a plurality of indicators that identifies behaviors indicating successful recovery, as well as behaviors indicating a relapse of problematic behaviors associated with addiction and/or a psychiatric disorder.

The RSFS method further comprises obtaining a set number of random toxicology screens (e.g. urine toxicology screens) from the recovering individual. The RSFS method further comprises inputting all information gathered from the structured dialogues, the survey questionnaires and the random urine toxicology screens into a customized contact management database system, such as a Sage ACT! and a web-based survey database management system, such as Survey Gizmo.

The contact management database and survey database management aspects of implementing the RSFS method creates 1) consistency of data collection; 2) a structured recovery process for the recovering individual; 3) accountability indicators that optimize recovery of the recovering individual; 4) transfer of relevant information to and from members of the support team; and 5) alerts that signal members of the recovery support team of any signs of difficulty the recovering individual may be experiencing. The use of prompts delivered by the contact management scheduling feature ensures that the advocates will conduct complete dialogues with each member of the recovery support team and therefore ensure complete data collections. In accordance with the preferred embodiment, the RSFS method of contact management and survey database management to monitor the recovering individual continues for a period of twelve months following the recovering person's completion of his/her course of treatment for a psychiatric or addictive disorder.

The invention encompasses engaging the individual undergoing treatment for a psychiatric and/or addictive disorder in conversation about the RSFS method while he or she is residing in a transitional living program (TLP) provided by a treatment facility and then transitioning the individual into the RSFS prior to being discharged from the treatment facility.

The system and method of the present invention generates prompts and informational communications keyed to the recovery support advocate making regularly scheduled telephone contact with the recovering individual. These regularly scheduled telephone calls are made in order to assess recovery progress and to redirect the recovering individual to his/her clinician(s) for any modifications of his/her continuing care plan; notifying the recovering individual of obligatory random urine toxicology screenings (which serve as an added measure of accountability); prompting the provision of non-judgmental, persistent support to the recovering individual in an ongoing effort toward independent, sustainable recovery; communicating information encouraging and supporting the personal contact of the recovering individual to practice support skills learned in transitional living family programs attended by the personal contact at the treatment facility; making a commitment to continue to work with the personal contact for the duration of the RSFS regardless of the recovering person's potential lack of engagement in the RSFS method; transmitting the availability of resource assistance to connect the recovering individual's personal contact with local family support programs; transmitting follow up communications to professional contacts including a series of brief and straightforward questions to determine if the recovering individual is attending scheduled appointments and engaging in his/her treatment and/or to allow the professional contact to express any concerns.

The invention further encompasses the recovery support advocate performing pre-discharge activities for his/her assigned recovering individual as well as completing a pre-discharge checklist to ensure completion of the pre-discharge activities. The pre-discharge activities are comprised of the following activities (for example, but not necessarily, performed in the following order):

i. the recovering individual attends a first RSFS group meeting and receives RSFS information and a Participation Agreement and a Consent to Contact form; and that the recovering individual is informed of random toxicology screens and associated out-of-pocket expenses;

ii. the recovering individual and a social worker begin a continuing care plan, and the social worker confirms the completion of the continuing care plan;

iii. the recovering individual's personal and professional contacts are identified;

iv. RSFS information is optionally provided to the personal contact while the recovering individual is admitted to the TLP;

v. the recovery support advocate collects the signed Participation Agreement and Consent to Contact Form from the recovering individual;

vi. the personal contact of the recovering individual usually attends a TLP Family Program;

vii. the recovery support advocate meets with the personal contact of the recovering individual;

viii. the recovery support advocate holds a final meeting with the recovering individual (and possibly the social worker) before discharge of the recovering individual;

ix. an RSFS letter informing the details of the RSFS method and copies of the Consent to Contact Form are sent to the professional contact of the recovering individual;

x. the continuing care plan and other relevant documents, including the treating psychiatrist's lab order for the urine toxicology screens are retrieved from the RSFS scan folder; and

xi. a first telephone call by the recovery support advocate to the recovering individual and the other members of the recovery support team is scheduled.

The recovering individual is given an RSFS participant number, which serves as a common identifier that links information from all database and survey sources that is inputted into the RSFS contact management database system and web-based survey database management system associated with implementing the inventive system to track and support the recovering individual's recovery process.

The invention further contemplates that a number of pre-planned structured communications, coupled with the data basing of templated information in an associated memory matrix, between the recovery support advocate and the recovering individual will occur once per week for the first three months of the one year period after discharge, once every other week for the next six months of the one year period after discharge, and once per month for the last 3 months of the one year period after discharge of the recovering individual from the treatment facility.

The invention further contemplates that a set number of pre-planned, structured communications, coupled with the data basing of templated information in an associated memory matrix, between the recovery support advocate and the personal contact of the recovering individual will occur bi-weekly during months 1 to 9 and once a month during months 10 to 12 after discharge of the recovering individual from the treatment facility. It is envisioned that the communication between the recovery support advocate and the personal contact continues even if the recovering individual is not in compliance with his/her continuing care plan, has withdrawn from the RSFS method, or generally is not participating in the pre-planned telephone follow-up calls.

The invention further contemplates that the structured communications, coupled with the data basing of templated information in an associated memory matrix, between the recovery support advocate and the professional contact can occur via the telephone, email or facsimile and will begin immediately upon the recovering individual's first appointment with the professional contact or day of arrival to the after-care facility in order to ensure that the recovering individual is complying with his/her continuing care plan. It is envisioned that communication and data basing of information between the recovery support advocate and the professional contact after the initial contact will occur once a month and, optionally, more than once a month if there are particular concerns either expressed by the recovering individual or the personal contact regarding the status of the recovering individual.

After each contact between the recovery support advocate and the other members of the recovery support team, a mutually agreed upon set of times, in which the recovery support advocate may best reach the other members of the recovery support team, is established. Each member of the recovery support team is provided with an office telephone number of the recovery support advocate in order to communicate with the recovery support advocate by telephone or by leaving a voicemail. The dates of all communication and the details of all the communication between the recovery support advocate and each member of the recovery support team is summarized and inputted into the RSFS ACT! database.

The invention further encompasses having the recovery support advocate administer survey questionnaires to the recovering individual, the personal contact and the professional contact in order to elicit information regarding the individual's adherence to his/her continuing care plan and need for any additional support during his/her recovery process. The long version of the patient survey is administered at week 1 and thereafter at months 3, 6, 9 and 12 after discharge from the treatment facility. The survey responses are input into a web-based survey database management system

The invention further encompasses having the recovering individual undergo a random urine toxicology screen weekly in months 1 to 3, bi-weekly in months 4 to 9, and monthly in months 10 to 12 after discharge from the treatment facility. This information is input into a web-based survey database management system.

The invention, therefore, creates four databases of survey information that tracks the progress of the recovering individual. The RSFS method also optionally implements a statistical evaluation of the behaviors, attitudes and other factors, together with outcomes, that will describe the course of recovery for each participant using the RSFS method of follow-up and support. The same may be used in a predictive model to improve outcomes by early intervention and to adjust the information collected in surveys to focus on, for example, more substantively valuable and statistically correlated information

Various recovery follow-up methods for when a person discharges from a treatment facility have been developed to address the lack of success that many individuals experience in their quest for recovery from addictive disorders.

For example, one program, referred to as AiR (Assistance in Recovery), provides a one-year recovery assistance program (RAP) which includes on-going meetings with the recovering individual and toxicology screening to substantiate the recovery process. A RAP manager is assigned to the recovering individual and provides positive reinforcement to the recovering individual and facilitates regular updates and communication with other persons in the recovering individual's life. This recovery program, however, does not include the inventive pro-active, regular communication time and content protocols engaged in by recovery support team comprised of a recovery support advocate, a recovering individual, a personal contact of the recovering individual, and a professional contact of the recovering individual. Furthermore, the program does not include the inventive information-gathering and data basing on a scheduled basis for information provided by the recovering individual, and the gathering and data basing of information through the personal contact and the professional contact during the twelve months following discharge of the recovering individual from a treatment facility.

U.S. Pat. No. 5,980,447 discloses an interactive multi-media computer system for providing support and guidance to an individual undergoing recovery from a substance or emotional dependency in which the recovering individual interacts with the computer system. The system does not include a support advocate that communicates with the recovering individual on a pro-active, pre-planned basis during the twelve months after the recovering individual is discharged from a treatment facility in order to assess compliance of the individual to his/her recovery process.

U.S. Pat. No. 7,778,847 discloses a method for determining an optimized surveillance schedule of follow-up diagnostic tests and doctor visits in order to determine the tradeoff between timely detection of relapse from a physical disease, such as cancer, and the cost of diagnostic procedures. The method does not provide a recovery support and follow-up service comprised of pro-active, pre-planned communication between members of a recovery support team, survey questionnaires administered on a scheduled basis to particular members of the recovery support team, random scheduled urine toxicology screens of the recovering individual, or the use of a database to input all information obtained.

U.S. 2006/0167723 discloses a treatment protocol that includes education and initial treatment of the addicted individual, group therapy and relapse prevention. The treatment protocol may also include a maintenance protocol after completion of the treatment protocol. These treatment protocols, however, do not include pro-active, pre-planned communication with the recovering individual by a health care advocate after the recovering individual is discharged from the treatment facility which lasts over a period of twelve months after discharge of the recovering individual. Nor does the treatment program include survey questionnaire information gathering completed on a scheduled basis by the recovering individual, the personal contact and the professional contact during the twelve months after discharge of the recovering individual from a treatment facility.

U.S. 2010/0228567 discloses an automated medication adherence system which is web-based and/or telephone-based in which enrolled participants can access the automated adherence system. The system solely is used to monitor the use of medication by an individual and does not provide recovery support or follow-up service to a recovering individual after discharge from a treatment facility.

U.S. 2006/0229914 discloses a multi-tiered support system for a recovering individual which includes providing support and monitoring the recovering individual's commitment to recovery. The support system only reaches out to the recovering individual by communicating with the recovering individual after the individual fails to complete a regularly scheduled activity, such as attending a twelve-step program, rather than communicating and supporting the recovering individual on a pro-active, pre-planned basis during the twelve months after the recovering individual is discharged from a treatment facility.

U.S. 2007/0250352 discloses a system for administering a health care system which includes up to five processing means and a database. The system includes means for insurance procurement, calculating treatment costs and disbursements, and means for detecting fraud. The system does not provide a recovery support team assist in the recovery process of a recovering individual during the twelve months after discharge of the recovering individual from a treatment facility.

U.S. 2011/0047508 discloses a system and method for recovery-based social networking in which icons related to emotional states are posted on a social network and used by a recovering individual as self-indicators. The system does not disclose a recovery support service which includes pro-active, pre-planned communication by a recovery support advocate with a recovering individual on a scheduled basis during the twelve months after the recovering individual is discharged from a treatment facility.

U.S. 2004/0267571 discloses a method for reducing the cost of health care by assessing individuals and determining which individuals have psychosocial issues that put the individual at risk for having a longer than normal recovery period. Recovery from addiction and/or psychological problems is not the primary goal of the assessment process.

U.S. 2011/0087501 discloses a web-based method using at least one computing device for automating a medical treatment. The method does not include taking and recording individual survey questionnaires by a recovering individual, a personal contact and a professional contact on a scheduled basis during a one year period following discharge of the recovering individual from a treatment facility.

In comparison to such, the inventive system provides a specialized monitoring and prevention regimen including recording reported positive toxicity results in a database of toxicity lapses along with associated information including the date of such lapses, the number of days of such lapses and the frequency of such lapses. The system further includes algorithms for storing and periodically checking accumulated information gathered by questionnaires (i.e., surveys), and a lapse-predicting algorithm in the memory of said computer meant to provide precautionary and high alert warnings to personnel involved in providing recovery support. In this manner, there is provided a lapse-predicting algorithm which is responsive to historical data respecting survey questions and lapses as built up from the experience of other patients. In addition, the invention contemplates reading toxicity lapses and associated information from a database of toxicity lapses, reading survey questions and answers from a database of survey questions and answers, measuring the correlation between survey questions and answers, on the one hand and toxicity lapses on the other hand, and assigning high correlation, medium correlation and low correlation ranks to such measured correlation. This is done with the object of later reporting, with respect to a particular patient, the results of a process comprising testing survey questions and answers collected in the course of the RSFS against known correlation to toxicity lapses. Such testing comprises determining whether there is a high correlation, medium correlation or low correlation between the data collected in the RSFS for the particular patient, and historical survey questions and answers associated with relapse into the addictive or similar behavior which resulted in hospitalization of the patient. Such high correlation, medium correlation or low correlation would correspond to a normal, precautionary or dangerous condition, respecting the danger of a relapse into the addictive or similar behavior which resulted in hospitalization of the patient.

### BRIEF DESCRIPTION OF THE DRAWINGS

A full understanding of the invention can be gained from the following description of the preferred embodiments when read in conjunction with the accompanying drawings in which:

FIG. 1 illustrates the initial treatment of a patient in accordance with the present method prior to the implementation of the inventive Recovery Support and Follow-up Service (RSFS) individual/participant contact and process flow chart according to the embodiments of the invention;

FIG. 2 illustrates the data flow and storage and numerical assessment in accordance with the RSFS method of the present invention;

FIG. 3 is a flowchart illustrating the inventive notification and database operating system;

FIG. 4 illustrates a system for implementing the method of the present invention; and

FIG. 5 shows a sample record from the database which contains information inputted for an RSFS individual/participant using the Sage ACT! software program.

### DETAILED DESCRIPTION OF THE INVENTION

As used herein, the terms “individual”, “recovering individual”, “RSFS participant”, and “individual undergoing recovery” are meant to be interchangeable.

As used herein, the terms “transitional living program patient”. “TLP patient” and “TLP addiction/dual disorders patient” are meant to be interchangeable.

As used herein, the term “personal contact” is meant to be interchangeable with the terms “family”, “family members”, and “significant other(s).”

As used herein, the term “professional contact” is meant to be interchangeable with the terms “out-patient clinician” and “a professional contact affiliated with an after-care facility.”

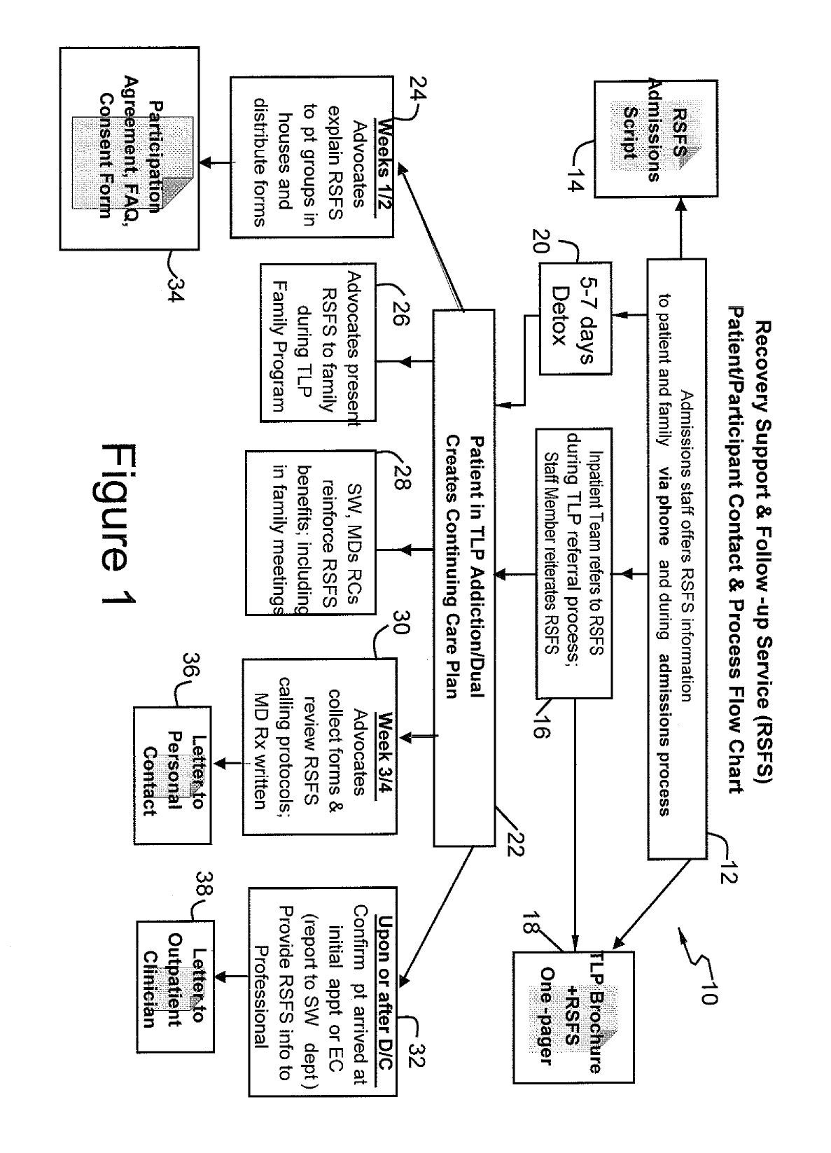

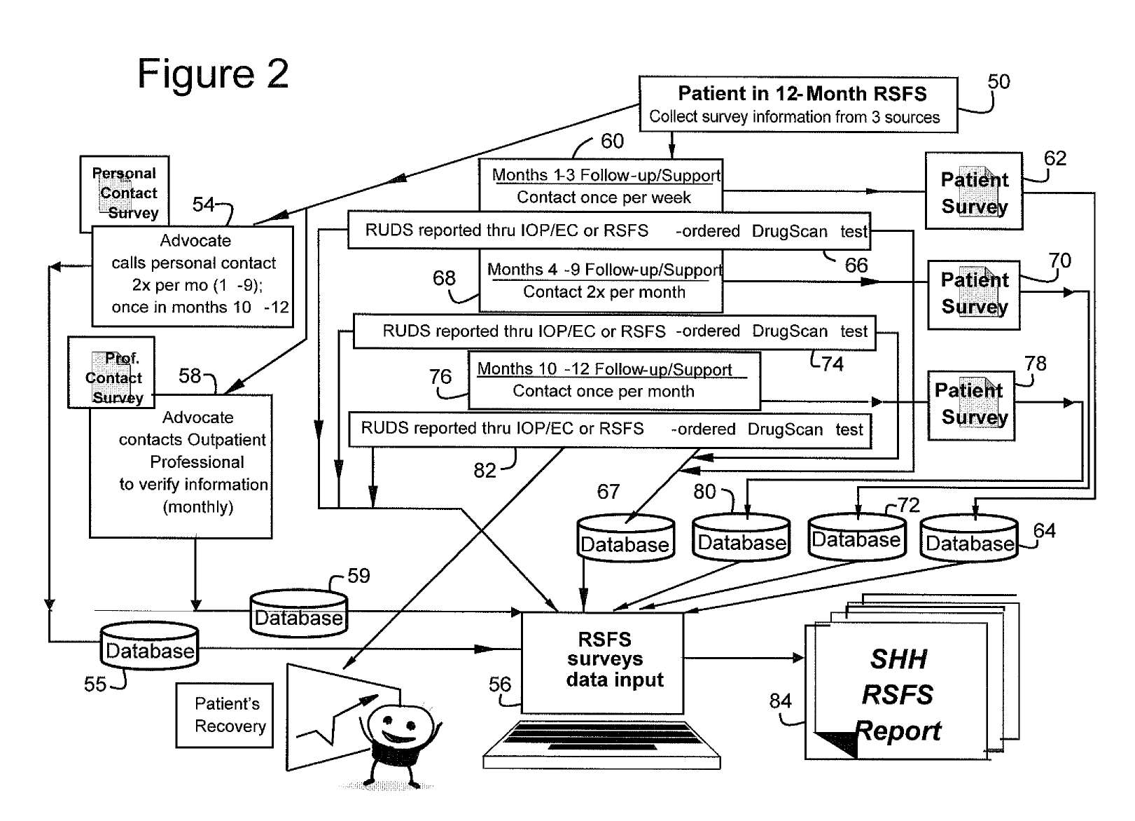

The inventive system may be applied to addiction disorders, psychiatric disorders (such as psychotic and mood disorders), or the combination of addictive and psychiatric disorders, which combination is referred to as a dual disorder. As shown in FIGS. 1-4, the inventive Recovery Support and Follow-up Service (RSFS) Individual/Participant Contact and Process flow chart is illustrated. The process of the present invention is implemented through a number of survey and communications documents that are detailed in Tables 1-12 and may be initially implemented substantially in the sequence in which they are numbered as will be apparent from the description below. Prior to admission of an individual to a treatment facility for addiction and/or (more particularly addiction and/or psychiatric disorders), an admissions staff offers RSFS information to the prospective individual and his/her family via telephone using a RSFS Admissions Script, as detailed in Table 2.

Such information in the admissions script also is provided to the individual and family during the admissions process. All transitional living program (TLP) individuals are automatically eligible and will be formally enrolled in the RSFS after successfully completing the TLP. After admission, an in-patient clinical team and a TLP liaison discusses RSFS with prospective TLP patients and/or their families. Description of the RSFS is part of a “TLP packet,” which also includes a TLP brochure and TLP Family Program information.

Once TLP patients begin their treatment, the RSFS method is introduced to each patient through the following actions: (1) the patient attends a meeting during his/her second week at the treatment facility with recovery support advocates who provide information regarding RSFS and a FAQ sheet. The patient is also given the opportunity to review and sign the RSFS Participation Agreement and Consent to Contact Form; (2) the recovery support advocates present RSFS to families of the individuals during a TLP Family Program; (3) social workers, doctors and residential counselors at the treatment facility reinforce the benefits of RSFS with individuals as well as in family meetings; (4) the recovery support advocates collect Participation Agreements and Consent to Contact forms and review communication protocols included in RSFS method with the TLP patients prior to discharging from the treatment facility; (5) the recovery support advocate sends a letter describing RSFS to the individual's personal contact; and (6) upon or after discharge of the individual, the advocate confirms that the individual arrived at his/her initial out-patient clinician's appointment or intensive out-patient program/extended care (IOP/EC) facility, and sends a letter describing RSFS to the out-patient clinician or IOP/EC facility.

Information regarding the recovery status of the recovering individual enrolled in RSFS after being discharged from a treatment facility is collected by having the recovery support advocate assigned to the recovering individual communicate in a series of planned, structured dialogues with the recovering individual, the personal contact of the recovering individual, and the out-patient professional clinician. Together, the recovering individual, the recovery support advocate, the personal, i.e. family member(s), and the out-patient clinician all make up the recovering individual's recovery support team. Specifically, the recovery support advocate contacts the recovering individual by telephone once per week for the first three months, bi-weekly for the next six months, and once per month for the last three months following discharge from the treatment facility. During these contacts, the recovering individual responds to questions prompted by a Participant Survey instrument that collects and stores the responses on a web-based survey database management system. In addition, a routine urine toxicology screen is taken at the same time intervals (weekly for the first 12 weeks; bi-weekly during months four through nine and monthly during months 10-12) and the results of the urine toxicology screens are recorded in the Drug Screening Result Survey instrument. The recovery support advocate contacts the personal contact of the recovering individual bi-weekly for the first nine months and then once per month for the last three months following discharge from the treatment facility. The personal contact responds to questions prompted by the Personal Contact Survey instrument that collects and stores the responses on a web-based survey database management system. The recovery support advocate contacts the out-patient clinician once per month during the twelve months following discharge of the recovering individual from the treatment facility. The clinician also responds to questions prompted by the Professional Contact Survey instrument that collects and stores the responses on a web-based survey database management system All information gathered from the communications between the members of the recovery support team, the Participant, Personal and Professional surveys and the routine urine toxicology screens (Drug Screening Result Survey) are inputted in a RSFS database contained in a computer readable medium. The information is then used to generate a RSFS Report regarding the recovering individual's recovery process, as well as an evaluation of the behaviors, attitudes and other factors that will describe the course of recovery for each participant and all participants using the RSFS method of follow-up and support.

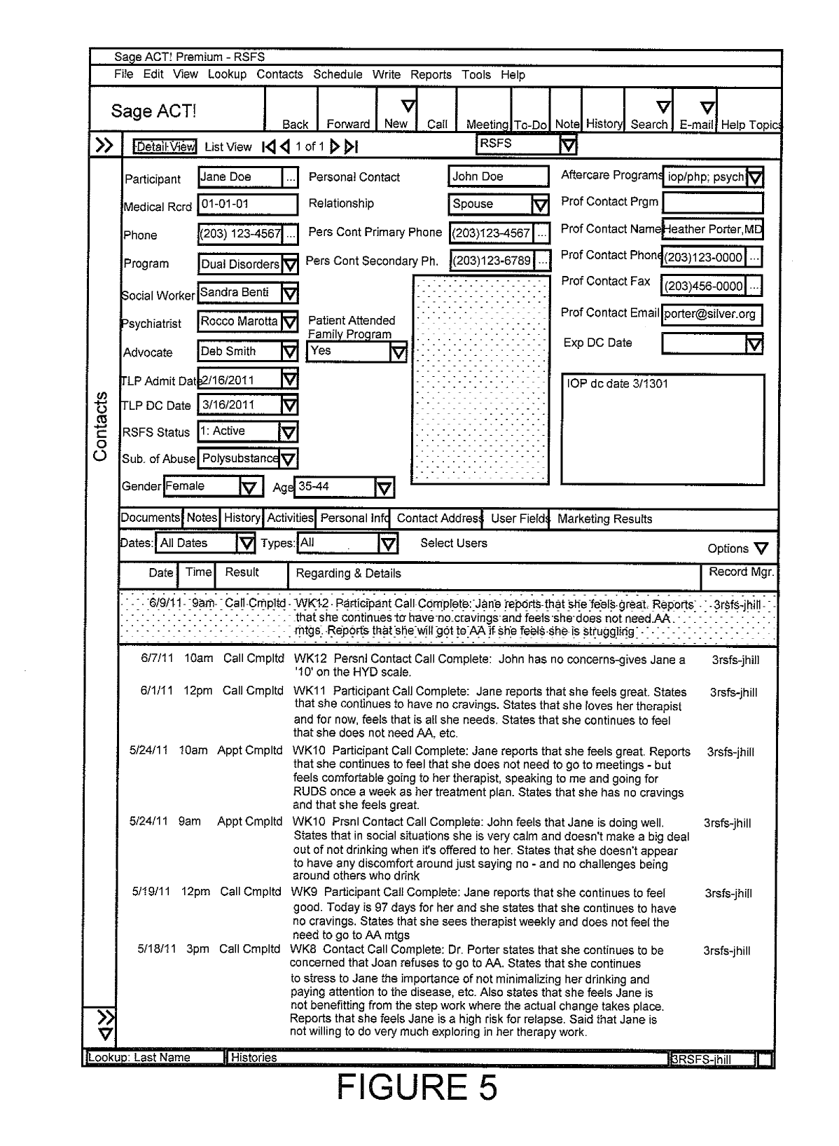

FIG. 5 is one sample record from the database used to input information for recovering individuals enrolled in RSFS using the Sage ACT! software program.

As shown in the sample database record, the following information is provided for each enrolled recovering individual: name, gender, age and phone number of recovering individual; RSFS participant number; program; name of social worker; name of psychiatrist; name of recovery support advocate; TLP admission date; TLP discharge date; RSFS status; substance of abuse; personal contact's name, primary and secondary phone numbers, and relationship to the recovering individual; aftercare programs; professional contact program; professional contacts name, phone number, fax and email address; expected discharge date; and information regarding all communications between the members of the recovery support team, specifically the date, time, result of communication, details regarding the communication and the identification number of the record manager (i.e., recovery support advocate assigned to each RSFS participant).

This database record is accessible to be seen by the advocates while they are communicating with recovering individuals, family members, professionals, and so forth. It is used by them to keep a historical record of information relevant to the recovering individual's successful adherence to his/her continuing care plan and to reference previous telephone contact with the recovering individual, personal contact or professional contact. The database record also records when a RSFS participant is requested to go for a random urine specimen collection and the results of the toxicology screen.

The object of the inventive method is Structure, Accountability and Support through Proactive Communication. The inventive Recovery Support and Follow-up Service (RSFS) is a comprehensive post-discharge support and follow-up service offered by a psychiatric hospital. Adult patients completing the hospital's 28-day, residential programs for psychiatric and/or addictive disorders are automatically eligible for the RSFS for the first 12 months after discharge at no additional charge. Participating in the RSFS therefore provides a 13-month relationship with the hospital for patients completing the inventive treatment program.

The RSFS does not provide treatment or case management services. The goals of the RSFS are to facilitate a smooth transition from treatment to recovery and to increase the likelihood of continued recovery during the first critical year. This is accomplished through an enhanced process of communication that will support the former patient in his/her efforts toward a better, healthier life; and keep open communication with families, significant others and professionals as they help the recovering person remain on track with his/her continuing care plan.

There are three key components of the inventive Recovery Support and Follow-up Service. First, the object is to establish a “recovery support team” made up of the patient; a hospital staff member, the “Recovery Support Advocate;” a family member or significant other; and a professional in the community, typically an outpatient clinician, who provides treatment and/or case management services.

Second, the advocate engages in a year-long series of planned, structured dialogues with each member of the team, designed to encourage the recovering person and to alert members of the team to any early signs of difficulty.

Third, the Advocate monitors the results of random (e.g. urine) toxicology screens, requested periodically through the year to allow the recovering person to demonstrate additional accountability.

A Recovery Support Advocate is assigned to each patient before s/he discharges from the hospital so that the patient and family members or significant others have the opportunity to establish a rapport with the Advocate. After discharge, the Advocate communicates regularly by telephone with all parties for a period of 12 months. The Recovery Support Advocate is neither a therapist nor a case manager. The Advocate's role is to support the patient's recovery by encouraging him/her to follow his/her continuing care plan and to facilitate the communication of relevant information between the members of the recovery support team. The Advocate can also respond to family needs by providing information about community resources.

The inventive Hospital Recovery Support and Follow-up Service is in keeping with an objective of providing continuing support to patients and their families in the critical phases of illness and recovery.

Information furnished to patients is listed in Table 3, typically at least before or in the early stages of the inventive method. The same may be communicated in a paper bulletin form, or orally by a recovery support advocate or by a member of the patient's treatment team, e.g., a social worker.

In accordance with the invention, the advocate surveys a number of individuals by telephone, including the clinician treating the recovering individual after the individual discharges from the Hospital, using an appropriate survey form (for example over the Internet or over a private network or on a Hospital computer). The contents of the survey form are filled in and stored on the system database. The particulars of these operations will be described in detail below. General directional information is provided to the Advocate as listed in Table 11

Advocates are provided with the general direction respecting their role in accordance with the present invention by being provided with information detailed in Table 1. This information may be provided in written, or oral form. An example form from a fictional “Smith Hospital” is presented.

The following are significant features of the inventive RSFS:
1. A recovery support team for the patient that includes a Hospital Recovery Support Advocate (advocate), a family member and a professional clinician contact
2. Recovery Support Advocates that are trained in specific communication protocols that maintain boundaries with the patient and his family/professional contacts
3. Coordination of communication within the recovery support team
4. A two-way release of information process that facilitates communication with all parties
5. Survey instruments that
   a. Track the patient's progress with his continuing care plan
   b. Include indicators that Hospital clinicians define as successful measures for recovery and also identify relapse behaviors
   c. Create the framework for structured communication with the patient to track his progress
   d. Create consistency in data collection
   e. Offer myriad of outcome measures
6. Use of individual patient's continuing care plan allows Advocates to customize dialogue with each patient during survey data collection
7. Customization of ACT! software to support the information tracking needs of the service
8. Provides support to family members as continuation of hospital's family program
9. Provides additional patient monitoring that assists aftercare clinicians
10. An internal review process to apply “real time” modifications to the RSFS using the expertise of a multidisciplinary management team.

The patient is asked to sign a form agreeing to the terms of the program. Preferably, this can be done at the beginning of the 28 day transitional living treatment, or at any time prior to the beginning of the recovery support program. The contents of the agreement are shown in Table 5.

To understand the work of the Recovery Support Advocate, it should be understood that the inventive Recovery Support and Follow-Up method is intended to be a comprehensive post-discharge service offered by a psychiatric hospital. Adult patients completing the Hospital's 28-day residential Transitional Living Program for psychiatric and addictive disorders are automatically enrolled for a period of 12 months.

The Recovery Support and Follow-up Service creates structure, accountability and support through proactive communication. The service helps patients make a smoother transition from treatment to recovery and supports personal responsibility and accountability, increasing the potential for long-term recovery. The goal of the service is to encourage the person in recovery to remain on track with his/her continuing care plan through a series of planned, structured dialogues designed to increase a person's desire and ability to stay in recovery during the first critical year. The service also requires that the recovering person submit to random urine toxicology screens, an action that creates additional accountability.

The service establishes a Recovery Support Team comprised of the patient; his/her outpatient clinician or program contact; a family member or significant other; and the Hospital Recovery Support Advocate A Recovery Support Advocate is assigned to each patient before s/he discharges from the hospital. The Advocate will facilitate communication between all the parties throughout the course of 12 months. The Advocate does not serve as a therapist, substance abuse counselor or case manager. The Advocate does not assess patients' needs, define goals or plan action and does not assist the patient in understanding his/her drug and alcohol dependency problems. The Advocate does not perform psychosocial assessments or make diagnoses.

During the patient's stay, the Recovery Support and Follow-up Service will be explained to families during their 4-day Family Program and/or the patient's individual family meetings with his/her social worker. After the patient discharges, the service helps maintain two-way communication with his/her family or significant others and also responds to family needs by providing information about supportive resources.

The Advocate's Interaction with Social Workers (or other outpatient professionals), Patients and Family Members is as follows:
1. Upon the patient's admissions or immediately thereafter, provide RSFS information to family member or significant other before they attend the 4-day Transitional Living Family Program. Coordinate necessary contact with family with the family program manager during the 4-day family program.
3. Meet with patients one-on-one or in a group setting prior to their discharge dates:
   a. Week 2: Patients new to TLP (Dual/Addiction) will attend an RSFS information meeting typically on Thursdays after the residential house morning meeting. The objectives are to explain the goal of RSFS and to review expectations for and the benefits of participation. Advocate will distribute Participation Agreement and Consent to Contact Form.
   b. Prior to discharge: Advocates will collect participation agreement and consent forms and review any questions about the follow-up procedures or drug screening protocols.
   c. During Family Program, provide family member or significant other with additional copies of RSFS information. Introduce assigned Advocate to family member.
4. Before discharge, contact the patient's social worker to get update or concerns related to providing the RSFS to the patient.
5. Send cover letter and copy of Consent to Contact Form to outpatient program or clinician.

The Advocate's Role During 12 Months of Service to Discharged Patients is as follows:
1. Explain goal of RSFS and review expectations to professional collateral contacts.
2. Follow-up with other members of participant's Recovery Support Team (family members or significant other-twice for first 9 months and then monthly; outpatient clinicians-monthly or as required).
3. Contact patient using the Recovery Support and Follow-up Service Questionnaire, which is designed to elicit information about the patient's adherence to his Continuing Care Plan and need for additional supports at each of the recommended follow-up times.

| Timeframe | Scheduled contacts | Total per timeframe |
|---|---|---|
| Months 1-3 | Once per week | 12 |
| Months 4-9 | Twice per month | 12 |
| Months 10-12 | Once per month | 3 |
| Total Contacts per Participant | | 27 |

4. Use web-based system and the RSFS ACT database to document the patient's responses. The patient's responses will be verified through information provided by the collateral contacts (i.e., family members, clinicians etc), which will also be documented.
5. Request patient to submit to random urine toxicology screens; document results.
6. When known, inform the Admissions Department of re-admissions.
7. Inform the director of social work when patients/families request information about community resources or seek additional referrals so that a member of the patients' original treatment teams may make the referrals.
8. Communicate pertinent feedback from outpatient clinicians/programs to the Marketing Department.

Advocates should have the following qualifications:
1. Bachelors or Masters in social work, psychology or related field.
2. Experience in the behavioral health and/or recovery field; experience with psychiatric or addicted patient population a plus. Knowledge of behavioral health resources
3. Strong customer service skills.
4. Strong computer skills, including Outlook, Word and Excel.
5. Strong written and verbal communication skills (over telephone and in person).
6. Self-starter; ability to work independently with great accountability.
7. Strong team player with willingness to take ownership of the overall effectiveness of the RSFS and make recommendations for quality improvement when warranted.

The Training and Orientation of advocates is as follows:
1. Attend HR-sponsored hospital orientation, including some clinical components to be specified.
2. Participate in Recovery Support and Follow-up training
   In accordance with the invention, each patient completes and signs a continuing care plan to achieve psychological sign on and to specify the elements of his/her recovery plan. The contents of the plan are listed in Table 4.

Table 4 is stored on the computer used to operate the inventive system and may be presented to the advocate via a shortcut hyperlink during the filling out of the patient survey.

In accordance with the invention, the patient is also required to fill out a consent to contact agreement, preferably on admission to the hospital for, by way of example, a 28-day residential treatment program, or, at the end of the 28-day residential treatment program, but in any case before the start of the Recovery Support & Follow-up Service. The contents of the consent to contact are listed in Table 6.

After the Consent to Contact form has been executed by the patient and at the commencement of the one year RSFS period, the hospital operating the system of the invention sends a letter to the personal contact, such as a significant other, treating the patient in the one year period following discharge, with the content of Table 7 (Letter to Personal Contact), below.

After the consent to contact has been executed by the patient and at the commencement of the one year RSFS period, the hospital operating the system of the invention also sends a letter to the clinician treating the patient in the one year period following discharge, with the following content of Table 8 (Letter to Professional Contact)<

The contents of a Personal Contact/Significant Other Survey in accordance with the invention are listed in Table 10,

The survey of Table 10, i.e., the Personal Contact Survey (like all the surveys of the invention described in this application) may be emailed with permission to the personal contact or may be filled out by the advocate speaking with the personal contact being surveyed over the telephone. However, it is preferred that the advocate complete the web-based survey while interviewing the recovering individual over the telephone.

Table 9 is a survey, i.e., the Patient Survey, which is used by the advocate during periodic interviews of the recovering patient.

Referring to FIG. 1, the initial phase of treatment of an individual with a psychiatric and/or addictive disorder may be understood. More particularly, the details of the inventive method 10 prior to the RSFS phase of treatment are illustrated in FIG. 1. In accordance with the inventive method 10, the process begins with admissions at step 12. During admissions, information respecting the inventive method is made available to patient and family during telephone conversations and during the admissions process. The objective is to obtain sign-on from the patient, and to enlist the support of family and other members of the personal support network with respect to such sign-on. Information is offered in accordance with a written script at step 14, for example at a meeting. The contents of the information in the written script are substantially identical to the information listed above in connection with the frequently asked questions.

During the process, repeated references are made to the inventive RSFS program during the transitional living program referral process at step 16. Information on the program is also included in a brochure given to the patient and family at step 18 during the admissions and the transitional living program referral process.

At step 20, if detoxification is required, the patient enters the hospital facility for a 5 to 7 day detoxification treatment. If detoxification is not required, after detoxification (or directly after admission where no detoxification is required) the patient is admitted to the transitional living program for 28 days at step 22. During this period while the patient is in treatment, the patient is encouraged to work out the details of the continuing care plan in the form illustrated above. As a practical matter, this generally occurs during the fourth week of the TLP at which point the patient is relatively stable and has had the benefit of the treatment program, and in better psychological condition to craft and sign-on to an acceptable plan. However, in certain cases crafting and signing onto a plan can occur in the first week of transitional living.

During the transitional living program, the patient lives in a residential facility separated into men's and women's houses. Each house is equipped with private sleeping quarters and bathrooms; common areas, including a kitchenette and is staffed by residential counselors 24 hours per day, seven days per week.

During the transitional living program, the Recovery Support and Follow-up Service method is explained to patient groups at step 24 during the first and second weeks, typically in the houses. Likewise, during this period, forms, including the participation agreement, the frequently asked questions, and the consent form are distributed to build consensus and buy-in among the patients. At step 26 advocates present the Recovery Support and Follow-up Service method to family members during the 4-day family program conducted in connection with the transitional living program.

Social workers, doctors and residential counselors who are present in the facilities speak with patients at step 28 reinforcing the inventive recovery support and follow-up service benefits. This includes meetings with family members.

During the third and fourth week, at step 30 advocates secure completed participation agreements and consent forms. In accordance with the invention, a national laboratory testing service is used, and the patient is provided with the location of a collection site near home or work to give a urine specimen that is later analyzed for the presence of alcohol or nonprescription substances.

At step 32, in accordance with the invention, the arrival of the patient at an initial appointment for an aftercare service is confirmed.

At step 34, collection of the participation agreement, FAQ and consent forms is confirmed, and at step 36 a letter is sent to the personal contact, such as the significant other, informing of the information contained in the exemplar of the letter listed above. The content of the letter is set forth in Table 7

At step 38 another letter also informing the consent of the patient is sent to the outpatient clinician, who may be a medical doctor, a psychiatrist, a social worker or other professional. The letter may take the form of Table 8.

In accordance with the invention, at step 50 the patient leaves the transitional living facility and returns home. During the one year period, immediately following the 28 day transitional living treatment, the patient returns home, but receives the benefit of recovery support and follow-up. More particularly, during this period advocates regularly communicate with the patient, and collect survey information. In addition, advocates contact and collect survey information from other team members, more particularly, the professional and the personal contact, such as a significant other, a family member, a coworker, a friend and so forth.

In accordance with the invention, surveys are conducted by having the advocate read the questions in the relevant surveys, as detailed above, and record the answers. Surveys may be used using a web-based survey service, which provides data recording and organization services via the Internet. This procedure may used in connection with all the surveys detailed in the specification.

More particularly, at step 54, the advocate contacts the personal contact twice a month during the first nine months of the recovery support procedure, and once a month during months ten through twelve of the recovery support procedure of the present invention.

At step 55, information collected in the survey of the personal contact is databased for present and future use as will be described below. This information is then sent to a computing device, such as a personal computer at step 56.

In similar fashion, at step 58, the advocate contacts the outpatient professional contact monthly during the recovery support procedure. In similar fashion also, at step 59, information collected in the survey of the outpatient professional is databased for present and future use as will be described below. This information is then sent to a computing device, such as a personal computer at step 56.

Further in accordance with the method of the present invention, the patient is contacted once per week during months 1-3 at step 60 and a patient survey is done by the advocate, and, at step 62, a patient survey is taken by the advocate. The information collected in the survey is databased at step 64. At step 56, this information is sent to the computing device for present and future use as will be detailed below. At step 66, a random toxicology screen is organized by requesting that the participant report to a laboratory (collection) site to give a urine sample for later toxicology analysis. The results of the random urine drug screen are databased and available to the advocate and other hospital staff together with all survey information referenced herein. The purpose of the toxicology screen is to determine the presence in the recovering patient of a non-prescribed substance, such as the substance from which the patient is recovering. This information is also sent to a database 67 after which it is furnished to the computing device at step 56.

Still further in accordance with the method of the present invention, the patient is contacted twice per month during months 4-9 at step 68 and a patient survey is done by the advocate. At step 70, a patient survey is taken by the advocate. The information collected in the survey is databased at step 72. At step 56, this information is sent to the computing device for present and future use as will be detailed below. At step 74, a random urine toxicology screen is organized to collect a urine sample from the patient in recovery. The purpose of the toxicology screen is to determine the presence in the recovering patient of an non-prescribed substance, such as the substance from which the patient is recovering. This information is also sent to a database 67 after which it is furnished to the computing device at step 56.

Yet further in accordance with the method of the present invention, the patient is contacted once per month during months 10-12 at step 76, and at step 78, a patient survey is taken by the advocate. The information collected in the survey is databased at step 80. At step 56, this information is sent to the computing device for present and future use as will be detailed below. At step 82, a random urine toxicology screen is organized to collect a urine sample from the patient in recovery. This information is also sent to a database 67 after which it is furnished to the computing device at step 56.

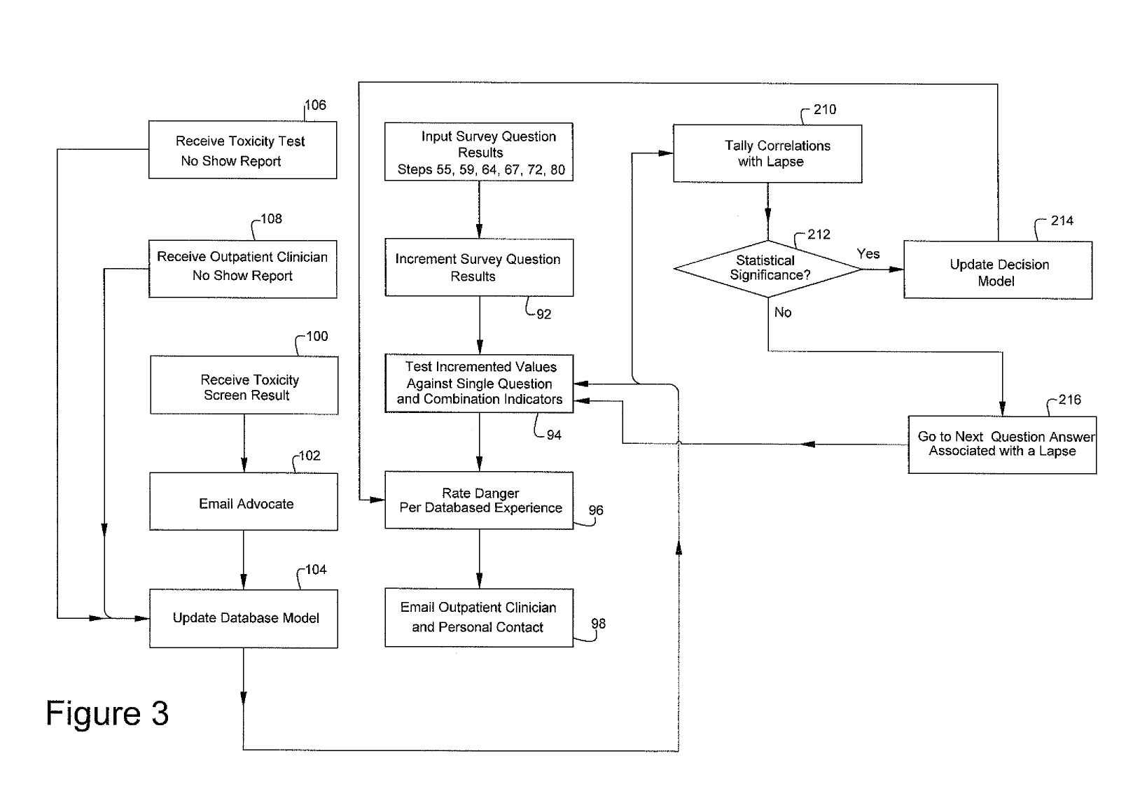

Referring to FIG. 3, in accordance with the present invention, as information is databased at steps 55, 59, 64, 67, 72, and 80, it becomes available for query via a web-based survey database management system Accordingly, at step 92, at periodic intervals, for example once each hour, the latest survey and toxicity results are queried by the system at step 94 and tested against danger indicators signified by single question answers, single question answers that have been repeated from survey to survey, and combinations of different answers to different questions and repetitions of the same which indicate normal recovery, reason for caution or danger. These danger indicators are a function of data collected by the inventive system over time. Such assessment is made at step 96. Optionally, at the end of each survey session the outpatient clinician and personal contact will be sent an e-mail at step 98.

At step 100 toxicity test results from the lab doing the random surprise drug screen are sent to the database coupled to the computer running the inventive system. In the event of a positive indication, the advocate is e-mailed at step 102. Following this, at step 104, the outpatient clinician and the family/personal contact also receive e-mails. This is made possible because of the consents executed by the recovering patient. The assessment made at step 96 is based on a database model used to assess normal, cautionary or dangerous conditions, which is are updated with the new information as described as described below and the statistical model is thus improved. Likewise, the reception of a no-show report for toxicity testing at step 106 and the reception of a no-show report from the outpatient clinician at step 108 cause the system at step 104 to update the statistical model for improved reliability and perhaps quicker response.

As shown in FIG. 3, the inventive apparatus also provides for generation and improvement on a model used for prediction of behavior and the output of danger indicators as described above. More particularly, as information is accumulated through the input into the system of responses to survey questions, the number of lapses associated with particular responses to survey questions are tallied at step 210. It is also contemplated that new questions, for example the multiple-choice questions of the examples detailed above, may be introduced and tested for their correlation to lapses into addictive behavior.

At step 212, it is determined whether the tallies made at step 210 are high and statistically significant, and may thus be used as predictors and a basis for warning advocates, members of the personal support network, and professional clinicians involved in the recovery support and follow-up method. Generally known statistical techniques are used to test correlation and assess reliability and significance as predictors. If statistical significance and a high correlation with relapses into addictive behavior (included within the term “lapse” in behavior as referred to herein), the particular question answer 9 or combination or repeats of the same) is used to update the decisional model at step 214. After such update, such information is taken into account by the system in connection with predictions made in warnings given pursuant to ratings of danger at step 96.

On the other hand, if no such statistical significance and high level of correlation corresponding to value as a predictive indicator is found, the system simply leaves the information in the database respecting the particular answer to a particular question as being associated with a lapse, for possible consideration as further data is achieved for possible association of the particular question-and-answer with a danger sign.

The process of testing individual questions for statistical significance as predictors of future addictive behavior is repeated, for example, for every selection (and optionally every combination and permutation) of particular question answers.

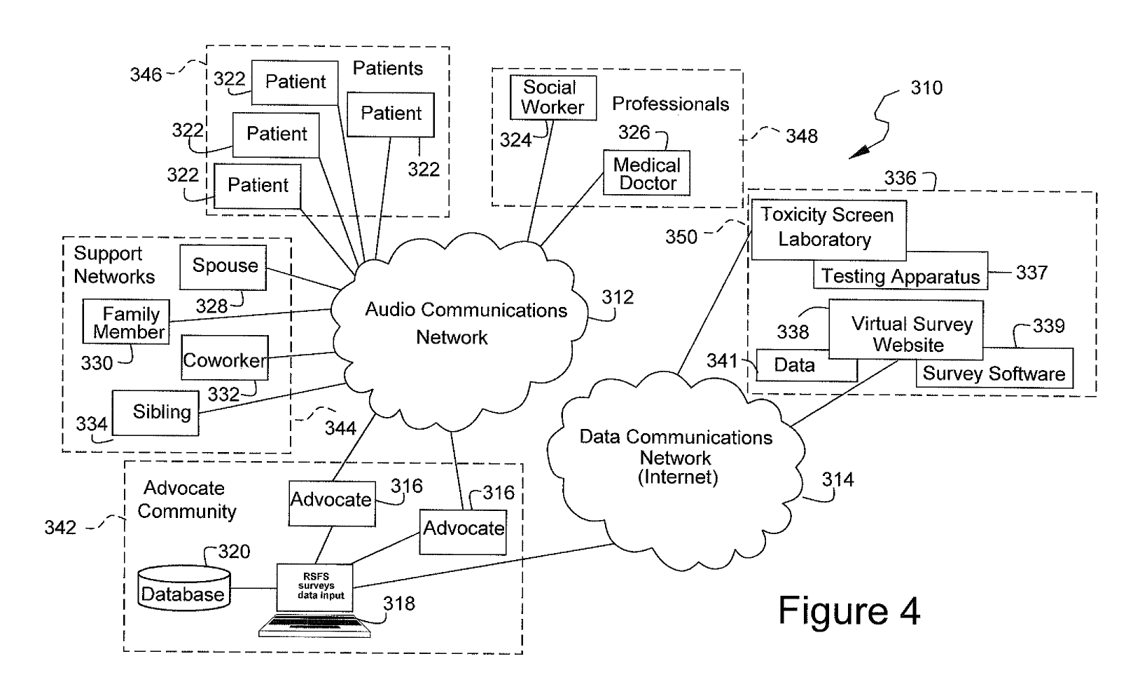

Referring to FIG. 4, a hardware system 310, comprising an audio communications system 312, such as the telephone system, and a data communication system 314, such as the Internet is used to implement the invention. Data input stations 316 associated with computers connected to a server 318 are used by advocates to input data. Data may be stored on a hard drive 320, whether obtained locally or downloaded from a remote location.

A plurality of patients uses conventional telephone equipment 322 to communicate with advocates over telephone system 312. Advocates also communicate with outpatient professionals, such as conventional telephones 324 used by social workers and telephone equipment 326 used by medical doctors. At the same time spouses, family workers, coworkers and siblings use telephone equipment 328-334 to communicate with the advocates in connection with survey generation, discussion of related issues, and so forth as described above.

Alternatively, medical doctors and other professionals may use the Internet 314 to communicate with advocates. However, it is preferred that all the communications with family members, patients, and so forth be of a more personal nature.

Communication with toxicity screen testing laboratories and survey software are preferably conducted over data communication system 314. More particularly, advocates may communicate by signing onto a laboratory server 336, which may be a simple personal computer or more advanced system which stores information output by testing apparatus 337, which information is associated with a particular person in recovery.

An appropriate drug screening survey is contained in Table 12

Drug screen survey

Likewise, communication with pre-existing surveys is achieved by an advocate using personal computer 318 to log onto the server computer 338 of the survey operator. Server computer 338 of the survey operator is operated by survey software 339 and accesses the database 341 of survey information.

In this manner, the advocate community 342 maintains contact with support network 344, patients 346, professionals 348 and service providers 350.

While the invention has been particularly shown and described with reference to embodiments described herein, it will be understood by those skilled in the art that various alterations in form and detail may be made therein without departing from the spirit and scope of the invention, as defined by the appended claims.

What is claimed is:

1. A method of measuring the likelihood that an individual recovering from a psychiatric and/or addictive disorder will relapse into an episode of such illness, comprising:
(a) storing queries forming a personal contact information receiving matrix in a personal contact information database;
(b) storing queries forming an outpatient professional information receiving matrix in an outpatient professional information database;
(c) storing queries forming a recovering individual information receiving matrix in a recovering individual information database;
(d) communicating a consent document to an individual who has or is scheduled to complete treatment for a substance-abuse and/or psychiatric disorder;
(e) receiving a consent from said individual who has or is scheduled to complete treatment for a substance-abuse and/or psychiatric disorder;
(f) storing in a personal contact information database information to be communicated to said personal contact of said recovering individual;
(g) communicating to said personal contact of said recovering individual from said personal contact information database said information to be communicated to said personal contact;
(h) storing in an outpatient professional information database information to be communicated to said outpatient professional treating said recovering individual;
(i) communicating to said outpatient professional treating said recovering individual from said outpatient professional information database said information to be communicated to said outpatient professional;
(j) reading said queries in said personal contact information receiving matrix in said personal contact information database and transmitting said queries to in said personal contact;
(k) reading said queries in said outpatient professional information receiving matrix in said outpatient professional information database and transmitting said queries to said outpatient professional;
(l) reading said queries in said recovering individual information receiving matrix in said recovering individual information database and transmitting said queries to said recovering individual;
(m) receiving responses to said queries in said personal contact information receiving matrix in said personal contact information database and communicating said queries to in said personal contact;
(n) receiving responses to said queries in said outpatient professional information receiving matrix in said outpatient professional information database and communicating said queries to said outpatient professional;
(o) receiving responses to said queries in said recovering individual information receiving matrix in said recovering individual information database and communicating said queries to said recovering individual;
(p) writing said responses to said queries in said personal contact information receiving matrix into said personal contact information database;
(q) writing said responses to said queries in said outpatient professional information receiving matrix into said outpatient professional information database;
(r) writing said responses to said queries in said recovering individual information receiving matrix into said recovering individual information database;
(s) inputting a lapse predicting algorithm into a computing device, said computing device communicating with said personal contact information, outpatient professional information and recovering individual information databases, said algorithm incorporating a model comprising information representing the correlation between responses to inquiries and said personal contact, out patient professional and recovering individual information databases;
(t) executing said lapse predicting algorithm using said responses to said queries and said personal contact, outpatient professional and recovering individual information databases to measure the correlation between said responses to said queries and said personal contact, outpatient professional and recovering individual information databases and relapse into a substance-abuse and/or psychiatric disorder.

2. A method as in claim 1, further comprising:
(u) communicating a measured high correlation between said responses to said queries in said personal contact, outpatient professional and recovering individual information databases and relapse into a substance-abuse and/or psychiatric disorder to said personal contact and outpatient professional; and
(v) executing an intervention designed to reduce the likelihood of relapse.

3. A method as in claim 1, further comprising communicating to said recovering individual the schedule for a chemistry-based measurement of the presence of any substance in the body of said recovering individual indicating a relapse into substance-abuse behavior and or a psychiatric condition, and executing said chemistry-based measurement.

4. A method as in claim 3, further comprising entering the results of said chemistry-based measurement into a database of toxicity information, said toxicity information and said responses to said queries in said personal contact, outpatient professional and recovering individual information databases being associated with said recovering individual and with the times associated with said results and said responses to said queries in said personal contact, outpatient professional and recovering individual information databases; and generating said model by measuring the correlation between said the sponsors to said queries in said personal contact, outpatient professional and recovering individual information databases and said toxicity information.

5. A method of providing a recovery support and follow-up service (RSFS) to an individual recovering from addiction and dual disorders, comprising the steps of:
(a) establishing a pro-active, pre-planned communication protocol comprised of a recovery support team comprised of an individual undergoing recovery, a recovery support advocate, a personal contact of the recovering individual, such as a family member or significant other, and a professional contact of the recovering individual, such as an out-patient clinician or a professional contact affiliated with an after-care facility;
(b) engaging in the pro-active, pre-planned communication protocol by having the recovery support advocate engage in a set number of scheduled, structured dialogues with the recovering individual, the personal contact and the professional contact, said structured dialogues comprised of the recovery support advocate providing and receiving information from each member of the recovery support team related to the recovering individual's progress in or challenges to his/her recovery;
(c) having the recovering individual, the personal contact and the professional contact at a scheduled set number of times complete a survey questionnaire comprised of a plurality of indicators that identify successful recovery as well as relapse behaviors of the individual undergoing recovery;
(d) obtaining a set number of random urine toxicology screens from the recovering individual; and
(e) inputting all information gathered from steps (a) through (d) into a software program database of a computer, said computer having stored in its memory a lapse-predicting algorithm, said lapse-predicting algorithm being responsive to historical data regarding answers to survey questions and lapses from recovery of individuals recovering from addiction by measuring the correlation between a number of the answers to the survey questions and positive toxicology screenings and assigning a high correlation, a medium correlation or a low correlation to the measured correlations; and reviewing answers to survey questions inputted into the database provided by the recovering individual and testing the answers against the measured correlations to positive toxicology screenings in order to report a high correlation, a medium correlation or a low correlation determination; and reporting a normal, precautionary or dangerous condition which corresponds to a low correlation, a medium correlation or a high correlation, respectively, and wherein the method of providing RSFS creates consistency of data collection, provides the recovering individual with a structured recovery process and accountability indicators which optimizes recovery of the recovering individual, facilitates and optimizes communication of relevant information to and from members of the support team, and alerts members of the recovery support team to any signs of difficulty the recovering individual may be experiencing.

6. The method according to claim 5, wherein the computer software program database is a Sage ACT! software program.

7. The method according to claim 5, wherein the RSFS provided to the recovering individual is for a period of about twelve months following discharge of the recovering individual from the treatment facility.

8. The method according to claim 5, wherein the individual undergoing recovery is entered into the RSFS while residing in a transitional living program (TLP) provided by the treatment facility prior to being discharged from the treatment facility.

9. The method according to claim 9, wherein a RSFS manager assigns a recovery support advocate to each recovering individual while in the TLP, and wherein the assignment by the RSFS manager is made to ensure a best fit between the recovery support advocate and the recovering individual.

10. The method according to claim 9, wherein the role of the recovery support advocate assigned to his/her recovering individual is comprised of making regularly scheduled phone contact with the recovering individual in order to assess recovery progress and redirect the recovering individual to his/her clinician(s) for any modifications of his/her continuing care plan; notifying the recovering individual when to take a random urine toxicology screening, said screening providing an added measure of accountability of the recovering individual; providing non-judgmental, persistent support to the recovering individual in an ongoing effort toward independent, sustainable recovery; encouraging and supporting the personal contact of the recovering individual to practice support skills learned in transitional living family programs attended by the personal contact at the treatment facility and making a commitment to work with the personal contact for the duration of the RSFS; providing resource assistance to connect the recovering individual's personal contact with local family support programs; contacting the professional contact of the recovering individual at a scheduled set number of times and asking the professional contact a series of brief and straightforward questions to assess recovery status of the recovering individual; and to report any expressed opinions about the RSFS made by the professional contact of the recovering individual to the RSFS manager.

11. The method according to claim 5, wherein the recovery support advocate performs pre-discharge activities with respect to his/her assigned recovering individual and completes a pre-discharge checklist to ensure completion of the pre-discharge activities, said pre-discharge activities comprised of the following activities:
i. that the recovering individual attends a first RSFS group meeting and receives RSFS information and a Participation Agreement and a Consent to Contact form; and that the recovering individual is informed of the need to take random urine toxicology screens and associated out-of-pocket expenses associated with the urine toxicology screens;
ii. that the recovering individual and a social worker begin a continuing care plan, and that the implementation of the continuing care plan is confirmed by the social worker;
iii. that the recovering individual's personal and professional contacts are identified;
iv. that RSFS information is provided to the personal contact after the recovering individual is admitted to the TLP;
v. that the recovery support advocate collects the Participation Agreement and Consent to Contact Form which have been signed by the recovering individual;
vi. that the personal contact of the recovering individual attends a TLP Family Program;
vii. that the recovery support advocate meets with the personal contact of the recovering individual;
viii. that the continuing care plan is completed, which completion is confirmed by the social worker;
ix. that the recovery support advocate holds a final meeting with the recovering individual and the social worker before discharge of the recovering individual;
x. that a RSFS letter and copies of the Consent to Contact Form are sent to the professional contact of the recovering individual;
xi. that the continuing care plan is retrieved from an RSFS scan folder; and
xii. that a first telephone call by the recovery support advocate to the recovering individual and the other members of the recovery support team is scheduled.

12. The method according to claim 5, wherein the recovering individual is given a RSFS Participant Number, which serves as a common identifier that links all information related to the recovering individual that is inputted into the RSFS computer software program database.

13. The method according to claim 5, wherein the set number of scheduled, structured dialogues between the recovery support advocate and the recovering individual or the recovery support advocate and the personal contact is by telephone, wherein the set number of scheduled, structured dialogues between the recovery support advocate and the professional contact is by telephone, email or facsimile, and wherein, after each contact between the recovery support advocate and the other member of the recovery support team, a mutually agreed upon set of times in which the recovery support advocate may best reach the other member of the recovery support team is established, wherein each member of the recovery support team is provided with an office telephone number of the recovery support advocate in order to communicate with the recovery support advocate by telephone or by leaving a voicemail, and wherein all communication and the dates of all communication between the recovery support advocate and each member of the recovery support team is summarized and inputted into the RSFS computer software program database.

14. The method according to claim 10, wherein the recovery support advocate communicates with the recovering individual by telephone for about 10 to 20 minutes once per week for the first three months, once every other week for the next six months and once per month for the last 3 months after discharge of the recovering individual from the treatment facility.

15. The method according to claim 10, wherein the recovery support advocate communicates with the personal contact bi-weekly during months 1 to 9 and once a month during months 10 to 12 after discharge of the recovering individual from the treatment facility, and wherein said communication with the personal contact continues even if the recovering patient is not in compliance with their continuing care plan, has withdrawn from RSFS or generally is not available.

16. The method according to claim 13, wherein the recovery support advocate communicates with the professional contact of the recovering individual immediately after the recovering individual's first appointment with the professional contact at his/her office or day of arrival to the after-care facility to ensure that the recovering individual is complying with his/her discharge plan.

17. The method according to claim 5, wherein the recovery support advocate communicates with the professional contact of the recovering individual once a month and, optionally, more than once a month if there are particular concerns which need to be discussed regarding the status of the recovering individual.

18. The method according to claim 5, wherein the recovering individual, the personal contact of the recovering individual and the professional contact of the recovering individual complete a survey questionnaire administered by the recovery support advocate at week 1 and thereafter at months 3, 6, 9 and 12 after discharge of the recovering individual from the treatment facility.

19. The method according to claim 5, wherein the recovering individual undergoes a random urine toxicology screen weekly in months 1 to 3, bi-weekly in months 4 to 9, and monthly in months 10 to 12 after discharge from the treatment facility.

20. A system for predicting relapse behavior of an individual recovering from addiction and/or psychiatric disorder after being discharged from a treatment facility, comprising periodically taking answers from survey questions and the results of random urine toxicology screenings from the recovering individual and inputting the answers and the results into a computer software program database, said computer having stored in its memory a lapse-predicting algorithm, said lapse-predicting algorithm being responsive to historical data regarding answers to survey questions and lapses from recovery of individuals recovering from addiction by measuring the correlation between a number of the answers to the survey questions and positive toxicology screenings and assigning a high correlation, a medium correlation or a low correlation to the measured correlations; and reviewing answers to survey questions inputted into the database provided by the recovering individual and testing the answers against the measured correlations to positive toxicology screenings in order to identify potentially dangerous situations.

21. The system of claim 20, wherein the survey contains danger indicators comprised of single question answers, single question answers that have been repeated from survey to survey or combinations of different answers to different questions and repetitions of the same which indicate normal recovery, reason for caution or danger, and wherein the danger indicators are compiled from historical data collection.

22. The system of claim 20, wherein the database is updated periodically with additional answers to survey questions and tested for their correlation to lapses in recovery from addictive behaviors.

23. The system of claim 20, further comprising utilizing a hardware system comprised of an audio communications system such as a telephone system and a data communications system such as the internet to report a normal, precautionary or dangerous condition to a personal contact, a recovery support advocate and an outpatient clinician of the recovering individual.

24. The system of claim 20, wherein data input systems associated with computers connected to a server are used by recovery support advocates to input data related to the recovering individual.

25. The system of claim 24, wherein data is stored on a hard drive, said data obtained locally or downloaded from a remote location.

26. The system of claim 23, wherein communication among the recovering individual, the recovering individual's recovery support advocate, personal contacts of the recovering individual, and one or more outpatient clinicians and/or social workers is by the telephone system.

27. The system of claim 23, wherein communication between the recovering individual's recovery support advocate and one or more outpatient clinicians and/or social workers is by the internet.

28. The system of claim 23, wherein the recovery support advocate of the recovering individual communicates with toxicology screening test laboratories and survey software over a data communication system such as the internet by signing onto a laboratory server which stores information output by a testing apparatus, said information associated with the recovery support advocate's assigned recovering individual.

29. The system of claim 23, wherein the recovery support advocate of the recovering individual achieves communication with pre-existing surveys by using a personal computer to log onto a server computer of a survey operator, said server computer operated by survey software which accesses a database of survey information.
